(19) United States
(12) Patent Application Publication
(10) Pub. No.: US 2024/0181365 A1
(43) Pub. Date: Jun. 6, 2024

(54) Balloon Garland Assembly

(71) Applicant: Totali EZ Balloons LLC, Scottsdale, AZ (US)

(72) Inventor: Erik Josephs, Scottsdale, AZ (US)

(73) Assignee: Totali EZ Balloons LLC, Scottsdale, AZ (US)

(21) Appl. No.: 18/526,130

(22) Filed: Dec. 1, 2023

Related U.S. Application Data
(60) Provisional application No. 63/429,289, filed on Dec. 1, 2022.

(51) Int. Cl. A63H 27/10; F16K 15/20; F16L 41/03

(52) U.S. Cl. CPC A63H 27/10; F16K 15/20; F16L 41/03; A63H 2027/1033

(57) ABSTRACT

A balloon garland assembly includes a frame assembly having a strut and a connector for coupling the strut to another strut. A socket is formed in the strut, the socket having an aperture formed through the strut and a gasket fit in the aperture. A balloon assembly is fit into the gasket, the balloon assembly comprising a balloon, an expander in a neck of the balloon, and a stem extending out from the expander away from the balloon. The stem is configured to fit into the gasket with a gas-impermeable fit.

### CROSS-REFERENCE TO RELATED APPLICATIONS

This application claims the benefit of U.S. Provisional Application No. 63/429,289, filed Dec. 1, 2022, which is hereby incorporated by reference in its entirety.

### FIELD

The present specification relates generally to decorations, and more particularly to balloon garland decorations.

### BACKGROUND

Balloon garlands are large structures formed of balloons. These decorative pieces are used at celebrations and are often arranged in the shape of an arch. The arches may be narrow, tall, wide, or short, or they may curved or squared or have some other shape. Sometimes the garlands are linearly arranged or assume another shape as desired and designed by the decorator.

Balloon garlands mimic the appearance of a flower garland but present a festive aesthetic with colored balloons. Like flower garlands, balloon garlands usually present a full, dense appearance by using a huge number of balloons. It is not unusual for a garland to require one hundred balloons or more. Designs often incorporate balloons of different sizes, colors, and even shapes.

There are a few conventional ways to create a balloon garland. One method involves tying balloons onto a single long piece of cord or flexible line. In another method, the loose necks of the balloons, beyond the knots, are sewn together in a series. In yet another method, balloons are attached to a balloon decorating strip, which is a long tacky length of tape to which balloons can be stuck and held in place.

Regardless of how they are constructed, balloon garlands always require an enormous amount of work to create and set up. Even the smallest ones can take three or four hours. Inflating the balloons takes a long time, as does arranging and attaching them together in a cohesive display. Balloons pop and have to be replaced during set up. If the decorator is also the party host, setting up the balloon garland can exhaust him or her long before the party even begins. A system or method for creating balloon garlands quickly and easily is needed.

### SUMMARY

In an embodiment, a balloon garland assembly includes a frame assembly having a strut and a connector. A socket is formed in the strut, the socket including an aperture formed through the strut and a gasket fit in the aperture. A balloon assembly is fit into the gasket, the balloon assembly including a balloon, an expander in a neck of the balloon, and a stem extending out from the expander away from the balloon. The stem is configured to fit into the gasket with a gas-impermeable fit.

In embodiments, the expander includes a disc-shaped body with an outer sidewall, and a bore extending centrally through the body, wherein the stem is fit into the bore. The outer sidewall is sealed to an inner surface of the neck of the balloon. The stem includes a one-way valve. The gasket includes an outer head disposed outside the strut, an inner butt disposed inside the strut, and a body extending between the outer head and inner butt. The body of the gasket has a smaller diameter than both the outer head and the inner butt. The stem flares outward from a base, fit into the expander, to a nozzle, fit into the gasket. The nozzle includes a radially-projecting lip. The nozzle has a cross-sectional shape of one of a rectangle, square, oval, circle, triangle, pentagon, hexagon, heptagon, nonagon, decagon, and star. The strut, connector, and socket are coupled in gaseous communication. The stem is rigid.

In an embodiment, a balloon assembly includes a balloon having a body and a neck, and an expander in the neck, urging the neck radially outward, wherein the expander has a disc-shaped body with a diameter, a central bore, and an outer sidewall. A stem is fit into the central bore and extends out from the expander and away from the balloon.

In embodiments, the outer sidewall is sealed to an inner surface of the neck. The outer sidewall has a height which is approximately one-third the diameter of the expander. The stem is rigid. The stem includes a one-way valve. The stem flares outward from a base, fit into the expander, to a nozzle, fit into the gasket. The nozzle includes a radially-projecting lip. The nozzle has a cross-sectional shape of one of a rectangle, square, oval, circle, triangle, pentagon, hexagon, heptagon, nonagon, decagon, and star.

In an embodiment, a balloon assembly includes a balloon having a body and a neck. A rigid expander is in the neck of the balloon, urging the neck radially outward, wherein the expander has a disc-shaped body with a diameter, a central bore, and an outer sidewall. A rigid stem is fit into the central bore and extending out from the expander and away from the balloon, wherein the stem includes a one-way valve enabling the admission of gas into the balloon body through the stem and disabling the emission of gas from the balloon body through the stem.

The above provides the reader with a very brief summary of some embodiments described below. Simplifications and omissions are made, and the summary is not intended to limit or define in any way the disclosure. Rather, this brief summary merely introduces the reader to some aspects of some embodiments in preparation for the detailed description that follows.

### BRIEF DESCRIPTION OF THE DRAWINGS

Referring to the drawings:

FIG. 1A is a front perspective view of two balloon garland assemblies;

FIG. 1B is a front perspective view of the balloon garland assemblies of FIG. 1A, with the balloons removed so that the frame assemblies are visible;

FIG. 2 is an enlarged perspective view of a base of balloon garland assembly of FIG. 1B;

FIG. 3 is an isolated perspective view of a balloon of one of the balloon garland assemblies of FIG. 1A;

FIG. 4 is a partial section view taken along the line 5-5 from FIG. 1A; and

FIG. 5 is an enlarged section view taken along the line 5-5.

### DETAILED DESCRIPTION

Reference now is made to the drawings, in which the same reference characters are used throughout the different figures to designate the same elements. Briefly, the embodiments presented herein are preferred exemplary embodiments and are not intended to limit the scope, applicability, or configuration of all possible embodiments, but rather to provide an enabling description for all possible embodiments within the scope and spirit of the specification. Description of these preferred embodiments is generally made with the use of verbs such as “is” and “are” rather than “may,” “could,” “includes,” “comprises,” and the like, because the description is made with reference to the drawings presented. One having ordinary skill in the art will understand that changes may be made in the structure, arrangement, number, and function of elements and features without departing from the scope and spirit of the specification. Further, the description may omit certain information which is readily known to one having ordinary skill in the art to prevent crowding the description with detail which is not necessary for enablement. Indeed, the diction used herein is meant to be readable and informational rather than to delineate and limit the specification; therefore, the scope and spirit of the specification should not be limited by the following description and its language choices.

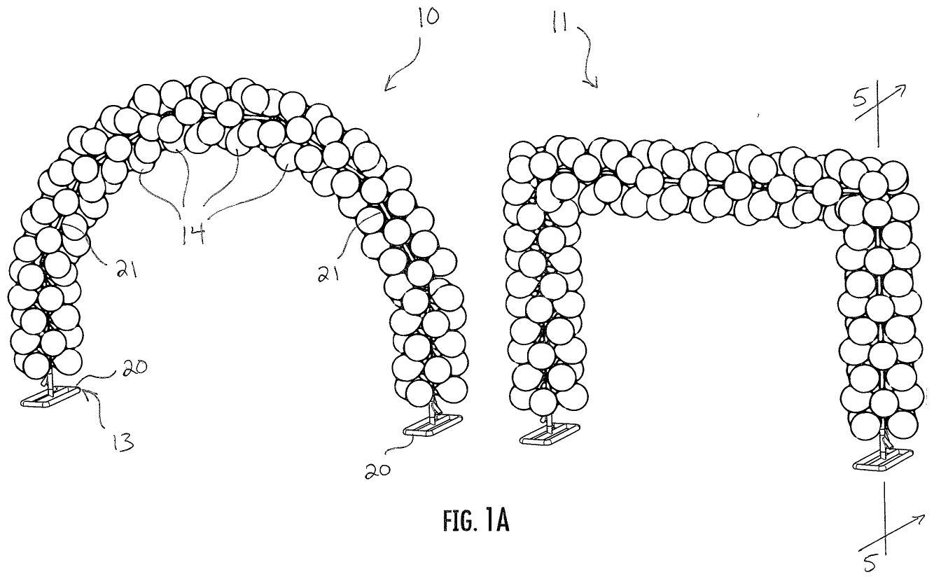

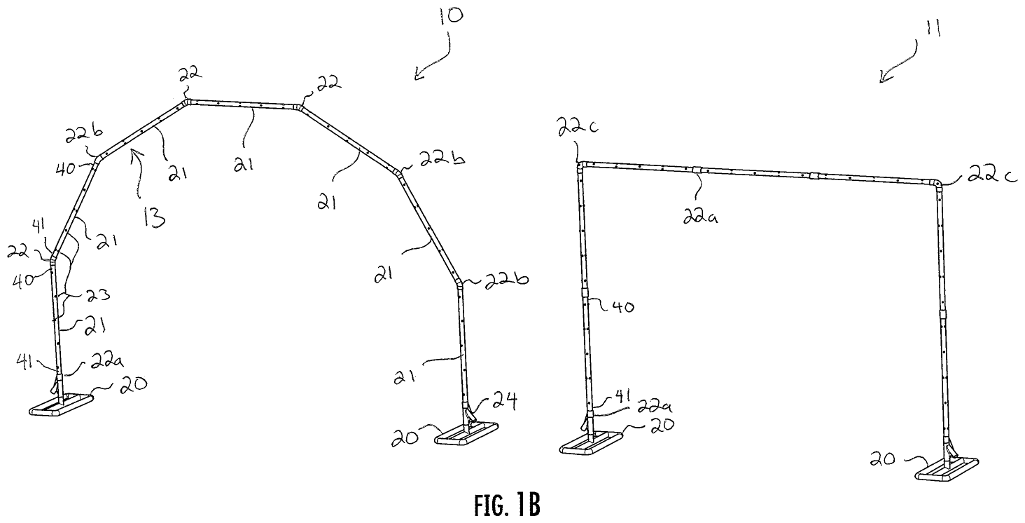

FIG. 1A illustrates two exemplary embodiments of balloon garland assemblies. On the left in the drawing, a balloon garland assembly 10 (hereinafter, the “assembly 10”) has an arched or arcuate shape. On the right, a balloon garland assembly 11 (hereinafter, the “assembly 11”) has a squared or rectangular shape. Most of the structural elements and features of these two assemblies 10 and 11 are identical, though some are only similar. The description herein refers primarily to the assembly 10, though it is equally applicable to the assembly 11 except as specifically noted. The assemblies 10 and 11 are merely exemplary assemblies, and other shapes and configurations are within the scope of this disclosure. Such configurations include, without limitation, a vertical linear arrangement, a horizontal linear arrangement, a triangular arrangement, a circular arrangement, a star arrangement, a car arrangement, a plane arrangement, a hat arrangement, a flower arrangement, and the like.

The assembly 10 is constructed from a number of constituent structural elements. Those elements are modular and can be combined and arranged in different combinations to build garlands of different sizes and shapes. The assembly 10 can carry dozens or hundreds of balloons, depending on the design arrangement.

The assembly 10 includes a frame assembly 13 covered with a large plurality of balloon assemblies 14. FIG. 1B shows both assemblies 10 with the balloon assemblies 14 removed. Referring now to both FIGS. 1A and 1B, the frame assembly 13 includes two bases 20, elongate legs or struts 21 extending upward from and between the bases 20, and connectors 22 coupling adjacent struts 21. When assembled in a desired arrangement as shown in FIG. 1A, the bases 20, struts 21, and connectors 22 form a continuous, contained system of pipes coupled to each other in gaseous communication. Each of these pieces is preferably hollow, such that when they are connected together, air, helium, or another gas may move through the frame assembly 13 without interruption or blockage. In other words, a gas introduced to one end of the frame assembly 11 communicates through the entire frame assembly 11 to an opposed, far end of the assembly 10.

The balloon assemblies 14 are coupled to the struts 21 in gaseous communication. Sockets 23 in the struts 21 allow the balloon assemblies 14 to tightly couple with the struts 21 so that the gas introduced to one end of the frame assembly 11 will not only communicate through the entire frame assembly 11 but will enter each balloon assembly 14 connected to the struts 21, so that the balloon assemblies 14 inflate with that gas. A decorator who has coupled hundreds of balloon assemblies 14 to the frame assembly 13 can create a large, beautiful balloon garland assembly in very little time.

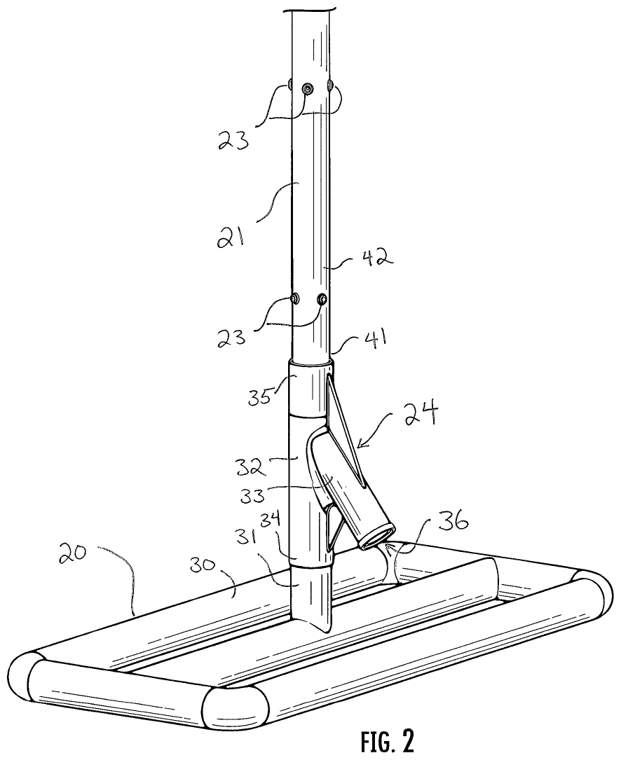

Turning now to FIG. 2, one of the bases 20 and a strut 21 are shown, coupled by an intake connector 24. The base 20 has a wide, low body 30 with an upstanding post 31 located centrally with respect to the body 30. The body 30 shown here is a framework, an assembly of several tubes. In other embodiments, the base 20 has a wide, low, truncated conical body with a flat bottom, a flat top, and a conical sidewall extending from the bottom to the top, and in other embodiments it may have some other form. The body 30 of the base 20 is preferably low so that a heavy sack or other weight can be placed on top of the base 20 to support the frame assembly 13 in the wind. The post 31 of the base 20 is cylindrical, integral, and unitary to the base 20. The post 31 has an outer diameter defining a mounting post for the intake connector 24.

The intake connector 24 has a main tubular body 32 and a port 33 extending from the body 32. The body 32 has a lower end 34 and an opposing upper end 35. At the lower end 34, the body 32 has an inner diameter which corresponds to the outer diameter of the post 31, such that when coupled, the two fit together in tight, air-impermeable engagement.

The port 33 is a hollow cylinder extending outwardly from the body 32 and diagonally downward toward the lower end 34 of the body 32. The port 33 terminates in a mouth or inlet 36. The inlet 36 is an entrance to the hollow port 33, which in turn is joined in gaseous communication with the body 32 of the intake connector 24. At the upper end 35, the body 32 has an inner diameter which corresponds to the outer diameter of the strut 21, such that when coupled, the two fit together in tight, air-impermeable engagement. Gas can thus flow through the inlet 36, through the port 33, up the body 32, and into the strut 21.

The struts 21 are preferably identical. As such, the structural elements and features of only one strut 21 are described here, with the understanding that the description applies to all struts 21 unless otherwise noted. The struts 21 are modular and fungible: each can be used in place of the other, and each can be used anywhere in the frame assembly 11 as desired by the decorator. FIG. 2 shows a strut 21 applied in the intake connector 24. FIG. 1B shows several struts 21 coupled together with connectors 24.

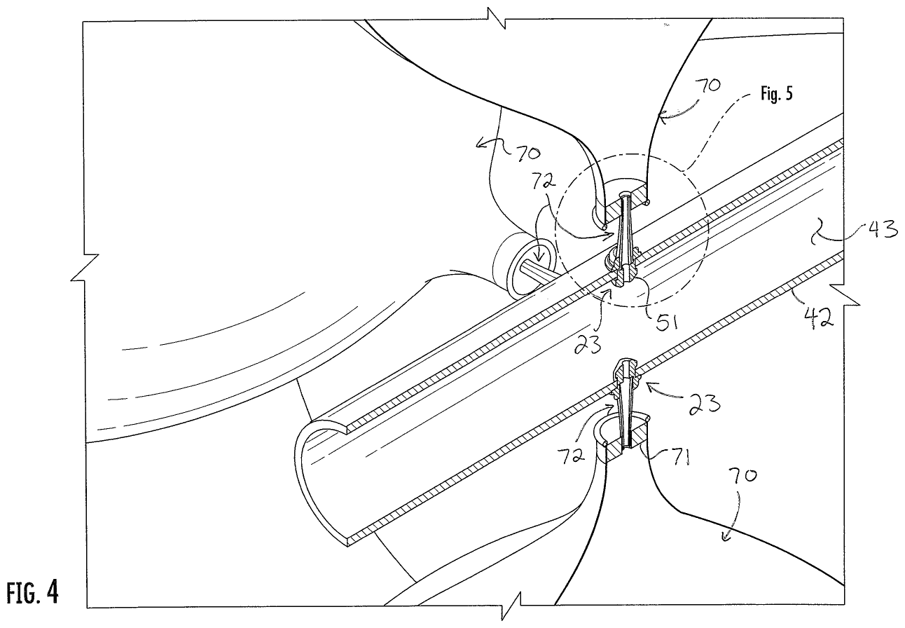

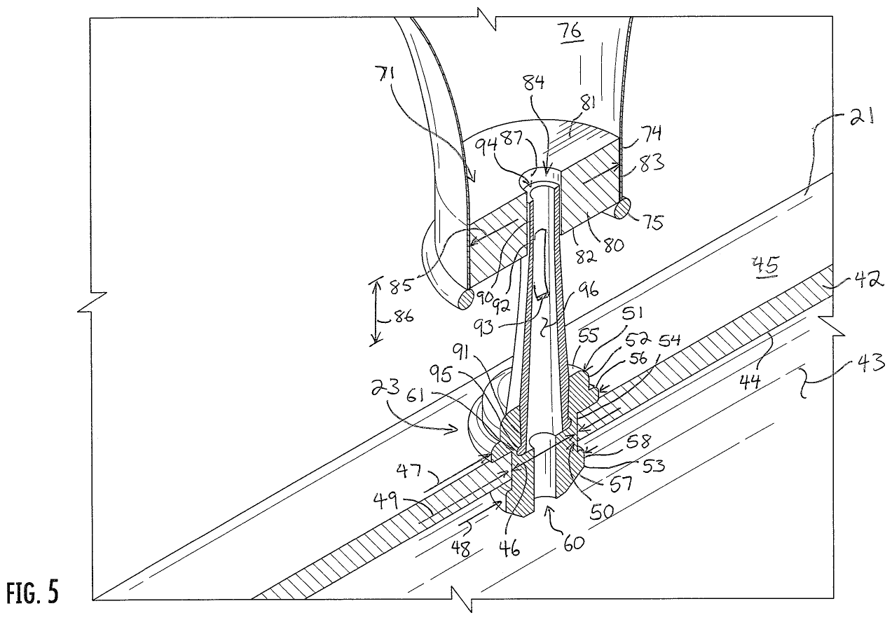

As shown in FIG. 1B, each strut 21 has a first or upper end 40 and an opposed second or lower end 41. The reader will understand that “upper” and “lower” are used here only for purposes of ease of identification and simplicity and that such naming conventions are not limiting. The strut 21 has a cylindrical sidewall 42 extending between the upper and lower ends 40 and 41. In other embodiments, the sidewall 42 may be square, rectangular, or have another cross-sectional shape. In other embodiments, the strut 21 has different lengths, too, and may even curvature or some shape other than straight. The sidewall 42 defines a continuous, hollow, elongate interior 43 (shown in FIGS. 4 and 5) which is enclosed except at the upper and lower ends 40 and 41 and at the sockets 23. As such, gas introduced at either end 40 or 41 can transmit through the strut 21 to the other end 41 or 40.

The struts 21 are coupled together with the connectors 22. The connectors 22 allow communication of gas between adjacent struts 21 and rigidly arrange adjacent struts 21 with respect to each other. There are many types of connectors 22, with three types shown in FIG. 1B.

Each connector 22 is a short cylindrical hollow stub. Each connector 22 has a cylindrical sidewall terminating in opposed open ends. The inner diameter of the connector 22 corresponds closely to the outer diameters of the struts 21 such that each strut 21 engages with the connector 22 in a tight, air-impermeable engagement. Moreover, the connector 22 is a rigid body, and connecting two adjacent struts 21 with a connector 22 ensures that the struts 21 are registered, aligned, and held and maintained in alignment and registration as desired.

One type of connector 22 is a coupling or straight connector 22a. Straight connectors 22a are shown in both assemblies 10 and 11 of FIG. 1B. It is straight. The straight connector 22a has opposed ends which are circular, coextensive, and coaxial with each other. The ends define open mouths which share a common central axis, because the ends are parallel to each other. Each of these connectors 22a forms a one-hundred-eighty degree angle between the adjacent struts 21 coupled thereto.

Another type of connector 22 is an obtuse elbow connector 22b. Obtuse elbow connectors 22b are shown only in the assembly 10 of FIG. 1B, not in the assembly 11. The obtuse elbow connector 22b has opposed ends which are circular and coextensive but are not coaxial. Rather, the ends define open mouths, each of which has an axis that is transverse to the axis of the other. The two axes of these mouths intersect to form an obtuse angle. Each of these connectors 22b forms an obtuse angle between the adjacent struts 21 coupled thereto.

Another type of connector 22 is a ninety elbow connector 22c. Ninety elbow connectors 22c are shown only in the assembly 11 of FIG. 1B and not in the assembly 10. Each of these connectors 22c forms a ninety-degree angle between the adjacent struts 21 coupled thereto. The ninety-degree connector 22c has opposed ends which are circular and coextensive but are not coaxial. Rather, the ends define open mouths, each of which has an axis that is set at a ninety-degree angle with respect to the axis of the other. Each of these connectors 22c forms a ninety-degree angle between the adjacent struts 21 coupled thereto.

Another type of connector 22 is an acute elbow connector. The drawings do not show an acute elbow connector, but it is similar to the obtuse elbow connector 22b except that the angle formed between the two coupled adjacent struts is acute, not obtuse. Another type of connector 22 is a tee connector, coupling three struts 21 at a single point. Another type of connector 22 is a cross connector, coupling four struts 21 at a single point. Other types of connectors 22 coupling two or more struts 21 in different configurations are considered within the scope of this disclosure.

When coupled with connectors 22 and to the bases 20, the struts 21 form the frame assembly 13, capable of conveying gas throughout the frame assembly 13 to the sockets 23. The struts 21 are carried all along the struts 21 and allow the balloon assemblies 14 to be attached to the frame assembly 13 and quickly inflated.

As seen in FIG. 2, there are several sockets 23 spaced apart along a strut 21. Three sockets 23 are visible at the top of the drawing, and two sockets 23 are visible below. The three sockets 23 above form a set, because they are registered with each other in a plane cutting through the strut 21, and the two sockets 23 below form a set, because they are registered with each other in another plane cutting through the strut 21. In this embodiment, each set of sockets 23 is rotationally offset with respect to an adjacent set of sockets 23, such that the sockets 23 of one set point in different radial directions than do the sockets 23 of an adjacent set of sockets 23. In other embodiments, the sockets 23 are not rotationally offset with respect to each other. Moreover, in other embodiments, the sockets 23 are arranged in different patterns. For instance, there may be a lesser or greater number of sockets in a set. The spacing between sockets 23 in a set may be smaller, larger, or varied. The sockets 23 may be arranged in patterns across the strut 21 outside of sets, such as in a helical pattern or some other pattern. The sets may be more densely or more widely spread apart than as shown in the drawings. And, in other embodiments, the sockets 23 are also in the connectors 23, to help create a fuller display of balloons on the assembly 10.

Each socket 23 is identical to the other but for location and orientation, and so the following description applies to all sockets 23. Turning to FIG. 5, which is an enlarged view of one of the struts 21 taken along the line 5-5 in FIG. 1B. The socket 23 includes an aperture 50 and a gasket 51 fit into the aperture 50.

The aperture 50 is a bore or through-hole formed entirely through the sidewall 42 of the strut 21. It is preferably, but not necessarily, circular in cross-section. The aperture 50 defines an inner diameter 46.

The gasket 51 is fit into the aperture 50 with a tight, gas-impermeable fit. The gasket 51 includes an outer head 52, an opposed inner butt 53, and a body 54 extending between and connecting the head 52 and butt 53. The head 52 includes a cap 55 and a flange 56 below the cap 55. Both the cap 55 and flange 56 are annular, with the flange 56 having a larger diameter 47 than the cap 55. In other words, the flange 56 extends radially outward further than the cap 55. The outer diameters of both the cap 55 and the flange 56 are larger than the inner diameter 46 of the aperture 50, such that the head 52 cannot fit through the aperture 50. Rather, the head overlies an outer surface 44 of the strut 21 immediately surrounding the aperture 50.

The butt 53 of the gasket 51 opposes the head 52. The butt 53 is disposed against an inner surface 45 of the strut 21, and the body 54 pulls the head 52 and butt 53 toward each other against the outer and inner surfaces 44 and 45, respectively. The butt 53 has a taper with an annular outer end 57 which is narrower in diameter than an annular inner end 58 and which tapers from the outer end 57 to the inner end 58. The diameter of the inner end 58 is marked with the reference character 48 in FIG. 5. The outer diameters of both the outer and inner ends 57 and 58 are bigger than the inner diameter 46 of the aperture 50, such that the butt 53 cannot fit through the aperture 50.

The body 54 of the gasket 51 is cylindrical and more slender than the head 52 and the butt 53. The body 54 has an outer diameter 49 which is just slightly larger than the inner diameter 46 of the aperture 50. The body 54 joins the head 52 and butt 53 integrally as a single, monolithic piece.

Indeed, the gasket 51 is a unitary piece, constructed from a material or combination of materials having durable and resilient material characteristics, such as rubber. When installed into the aperture 50, the gasket 51 is both compressed and stretched. The outer diameter 49 of the body 54, which is just larger than the inner diameter 46 of the aperture 50 in a neutral, uncompressed state, becomes compressed when applied to the aperture 50, acting to seal the sidewall of the body 54 against the inner wall of the aperture 50. Moreover, when the gasket 51 is installed in the aperture, the body 54 lengthens. Out of the aperture and under no force, the body 54 has a length between the head 52 and the butt 53 which is just less than the thickness of the sidewall 42. As such, when the gasket 51 is applied to the aperture 50 and the head 52 is disposed against the outer surface 44 and the butt 53 is disposed against the inner surface 45, the body stretches and lengthens to match the thickness of the sidewall 42. Because the gasket 51 is resilient, however, the body 54 pulls the head 52 and butt 53 inward and toward each other, acting to seal the head 52 against the outer surface 44 and the butt 53 against the inner surface 45. In these ways, the gasket 51 forms an air-impermeable fit with the aperture 50.

The gasket 51 includes a bore 60 extending centrally through the gasket 51 from the head 52 to the butt 53. The bore 60 is a path for the transmission of gas from one side of the gasket 51 to the other. The bore 60 has an annular channel 61 extending radially outward from the bore 60 and into the gasket 51 itself. The channel 61 is round and extends entirely around the bore. The channel 61 is located just inboard of the head 52, or just below the flange 56, and when the gasket 51 is properly fit in the aperture 50, the channel 61 is located just inboard of the outer surface 44 of the strut 21.

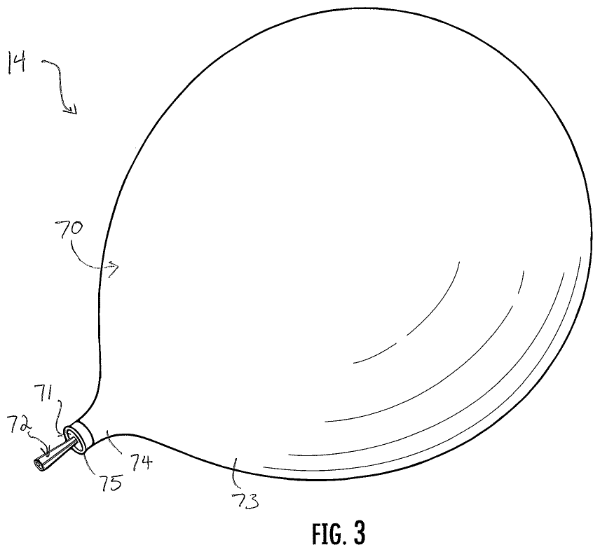

The bore 60 receives the balloon assembly 14 and couples it in gaseous communication with the interior 43 of the strut 21. FIG. 3 shows the balloon assembly 14. The balloon assembly 14 includes the balloon 70 itself, an expander 71 set inside the 70, and a stem 72 extending outward from the expander 71.

The balloon 70 has a balloon body 73 which can be inflated and expanded. The balloon body 73 is formed integrally to a neck 74, which largely resists expansion when the body 73 is expanded. The neck 74 terminates in a lip 75, which is a dense ring of material at the end of the balloon 70.

The expander 71 is shown more clearly in FIG. 5. The expander 71 has a disc-shaped rigid body 80 having an inner face 81, an outer face 82, an outer sidewall 83, and a bore 84 through the middle of the body 80. The inner and outer faces 81 and 82 are circular and coaxial and have a common outer diameter 85, which is the outer diameter of the expander 71. The sidewall 83 has a height 86 between the inner and outer faces 81 and 82 which is approximately one-third of the diameter 85 of those faces 81 and 82. The expander 71 is disposed within the neck 74 of the balloon 70, just inboard of the lip 75. The expander 71 urges the neck 74 radially outward in resilient engagement. This forms an air-impermeable seal between the expander 71 and an inner surface 76 of the balloon 70. In some embodiments, sonic welding, an adhesive, or some other means seals the expander 71 to the inner surface 76.

The bore 84 extends centrally through the expander 71, entirely between the inner and outer faces 81 and 82. The bore 84 is defined by an annular inner wall 87 of the expander 71. The stem 72 is fit into the bore 84, either by a press-fit engagement or some other fit that forms an air-impermeable fit between the stem 72 and the inner wall 87. The stem 72 extends outward from the expander 71 away from the balloon 70.

Still referring to FIG. 5, the stem 72 includes a base 90, an opposed nozzle 91, and a sidewall 92 extending from the base 90 to the nozzle 91. The sidewall 92 of the stem 72 is rigid, and so the entire stem 72 is rigid. The stem 72 further includes an internal valve 93 that controls the passage of gas within the stem 72.

The base 90 of the stem 72 is a slender cylinder. It terminates in a mouth 94 (at the top of the stem 72 as shown in the orientation of FIG. 5). The mouth 94 is circular and has an outer diameter corresponding in size and shape to the bore 84 of the expander 71. The entirety of the base 90 has this outer diameter and is tight fit into the bore 84 to form an air-impermeable fit. Below the expander 71, the sidewall 92 of the stem 72 flares outward to the larger outer diameter of the nozzle 91.

The nozzle 91 is fit into the gasket 51. The nozzle 91 is a larger cylinder than the base 90. It terminates at a lip 95, which is annular flange projecting radially outward.

The lip 95 is received by and set into the channel 61 in the gasket 51. The outer diameter of the lip 95 is just slightly larger than the inner diameter of the channel 61, so that the lip 95 and channel 61 form a tight, air-impermeable seal. When so fit this way, the lip 95 of the stem 72 is inboard of the outer surface 44 of the strut 21 and compresses the material of the body 54 of the gasket 51 radially against the aperture 50. This increases the tightness of the fit between the stem 72, the gasket 51, and the strut 21.

In this embodiment, the nozzle 91 and the lip 95 have a cross-sectional shape which is circular. However, this is not limiting. In other embodiments, the nozzle 91 and the lip 95 have a cross-section which has the shape of a rectangle, square, oval, triangle, pentagon, hexagon, heptagon, nonagon, decagon, star, or other shape, regular, irregular, or otherwise.

The stem 72 further includes an internal bore 96 extending entirely from base 90 to the nozzle 91. The bore 96 allows gas to communicate entirely through the stem 72. The valve 93 is disposed within the bore 96. The valve 93 is a one-way valve and is a flap of material extending from one side of the bore 96 to an opposed side and is shaped to fit against the interior of the bore 96. The valve 93 flaps; it is moveable, and it moves to open and close the bore 96. When gas is transmitted from the interior 43 of the strut into the gasket 51 and into the stem 72, the gas pushes the valve 93 against the side of the bore 96 to open the bore 96, thereby allowing the gas to move into the balloon body 73 and thus inflate the balloon 70. When gas has stopped transmitting from the interior 43, the flap snaps back across the bore, sealing against the bore 96 to close the bore 96, thereby preventing the gas from moving out of the balloon body 73. In this way, the valve 93 selectively enables the admission of gas into the balloon body 73 through the stem 72 and disables the emission of gas from the balloon body 73 through the stem 72. The valve 93 has other forms in other embodiments. For example, the valve 93 may be a diaphragm or check valve capable of enabling admission of gas but disabling emission of it.

In operation, the assemblies 10 and 11 are useful for a decorator or party host to quickly build a decorative and festive display. In one manner of doing so, the host places one or two bases 20 on the ground or mounts them to a vertical surface. As already explained above, this disclosure contemplate the creation of all different types of shapes and configurations of the balloon garland assembly described herein. This section of the description refers to the construction of the assembly 10 because it is shown in the drawings, but the reader should understand, after reading the below, how to construct any other shape and configuration with the structural elements and features described above.

The host places two bases 20 on the ground, spaced apart. The hose then couples a strut 21 to each one, then a connector 22 to the upper ends 40 of those struts 21, then another two struts 21, then another connector 22, and so on. To build the assembly 10, the host uses obtuse connectors 22b. The host does this until the arch of the assembly 10 is formed.

The host then takes a large number of balloon assemblies 14 and plugs them into the sockets 23. The host does this by grasping the stem 72, registering the nozzle 91 with the bore 60 in the head 52 of the gasket 51, and then pushing the nozzle 91 into the bore 60. The host does this until hearing or feeling a small click or pop, indicating that the lip 95 of the stem 72 has snapped into the channel 61 in the body 54 of the gasket 51.

The host does this over and over for all the balloon assemblies 14 that the host wants to put on the garland assembly 10. The host may choose to fill every socket 23 or only some of the sockets 23.

The host then couples an air pump to the inlet 36 of the base 20. Generally, a single air pump attached to a single inlet 36 is sufficient to inflate all the balloon assemblies 14. However, in large assemblies 10, the host may wish to attach an air pump to the inlet 36 of both bases 20 and inflate from both sides of the assembly 10.

The host runs the air pump to transmit gas (here, preferably, air or helium) into the base 20, into the struts 21, and then into balloon assemblies 14. The valves 93 in the balloon assemblies 14 snap open to enable the admission of air into the balloon bodies 73. Typically, less than a minute is required to inflate all of the balloon assemblies 14. The host can easily construct and inflate the balloon garland assembly 10 in less than ten or twenty minutes. When the balloon assemblies 14 are inflated, the host turns the air pump off. The valves 93 in the balloon assemblies 14 snap closed and remain closed, keeping the balloon assemblies 14 inflated.

In another method of construction, the host picks up a single strut 21 and installs balloon assemblies 14 in that strut 21. Capping one end of the strut 21, the host can connect the other to a pump, and operate the pump to inflate the balloon assemblies 14 on that strut. When the host turns the pump off, the balloon assemblies 14 remain inflated. The host can put that strut 21 and pick up another one and inflate its balloon assemblies 14. The host can do this over and over until there are many struts 21 on which the balloon assemblies 14 are inflated. The host can then assemble the frame assembly 11 by connecting these struts 21 to each other.

A preferred embodiment is fully and clearly described above so as to enable one having skill in the art to understand, make, and use the same. Those skilled in the art will recognize that modifications may be made to the description above without departing from the spirit of the specification, and that some embodiments include only those elements and features described, or a subset thereof. To the extent that modifications do not depart from the spirit of the specification, they are intended to be included within the scope thereof.

1. A balloon garland assembly comprising:
a frame assembly comprising a strut and a connector for coupling the strut to another strut;
a socket formed in the strut, the socket comprising an aperture formed through the strut and a gasket fit in the aperture; and
a balloon assembly fit into the gasket, the balloon assembly comprising a balloon, an expander in a neck of the balloon, and a stem extending out from the expander away from the balloon;
wherein the stem is configured to fit into the gasket with a gas-impermeable fit.

2. The balloon garland assembly of claim 1, wherein the expander comprises:
a disc-shaped body with an outer sidewall; and
a bore extending centrally through the body, wherein the stem is fit into the bore.

3. The balloon garland assembly of claim 2, wherein the outer sidewall is sealed to an inner surface of the neck of the balloon.

4. The balloon garland assembly of claim 1, wherein the stem includes a one-way valve.

5. The balloon garland assembly of claim 1, wherein the gasket includes an outer head disposed outside the strut, an inner butt disposed inside the strut, and a body extending between the outer head and inner butt.

6. The balloon garland assembly of claim 5, wherein the body of the gasket has a smaller diameter than both the outer head and the inner butt.

7. The balloon garland assembly of claim 1, wherein the stem flares outward from a base, which is fit into the expander, to a nozzle, which is fit into the gasket.

8. The balloon garland assembly of claim 7, wherein the nozzle includes a radially-projecting lip.

9. The balloon garland assembly of claim 7, wherein the nozzle has a cross-sectional shape of one of a rectangle, square, oval, circle, triangle, pentagon, hexagon, heptagon, nonagon, decagon, and star.

10. The balloon garland assembly of claim 1, wherein the strut, connector, and socket are coupled in gaseous communication.

11. The balloon garland assembly of claim 1, wherein the stem is rigid.

12. A balloon assembly comprising:
a balloon having a body and a neck;
an expander in the neck, urging the neck radially outward, wherein the expander has a disc-shaped body with a diameter, a central bore, and an outer sidewall; and
a stem fit into the central bore and extending out from the expander and away from the balloon.

13. The balloon assembly of claim 12, wherein the outer sidewall is sealed to an inner surface of the neck.

14. The balloon assembly of claim 12, wherein the outer sidewall has a height which is approximately one-third the diameter of the expander.

15. The balloon assembly of claim 12, wherein the stem is rigid.

16. The balloon assembly of claim 12, wherein the stem includes a one-way valve.

17. The balloon assembly of claim 12, wherein the stem flares outward from a base, which is fit into the expander, to a nozzle.

18. The balloon assembly of claim 17, wherein the nozzle includes a radially-projecting lip.

19. The balloon assembly of claim 17, wherein the nozzle has a cross-sectional shape of one of a rectangle, square, oval, circle, triangle, pentagon, hexagon, heptagon, nonagon, decagon, and star.

20. A balloon assembly comprising:
a balloon having a body and a neck;
a rigid expander in the neck of the balloon, urging the neck radially outward, wherein the expander has a disc-shaped body with a diameter, a central bore, and an outer sidewall; and
a rigid stem fit into the central bore and extending out from the expander and away from the balloon, wherein the stem includes a one-way valve enabling admission of gas into the balloon body through the stem and disabling emission of gas from the balloon body through the stem.
